(19) United States
(12) Patent Application Publication
(10) Pub. No.: US 2005/0063868 A1
(43) Pub. Date: Mar. 24, 2005

(54) Method of measuring surfactant penetration in an air filter assembly

(75) Inventors: Ryan E. Grimes, Dearborn, MI (US); James J. Kempf, Canton, MI (US)

Correspondence Address: BRINKS HOFER GILSON & LIONE/CHICAGO/COOK, PO BOX 10395, CHICAGO, IL, 60610, US

(73) Assignee: Visteon Global Technologies, Inc.

(21) Appl. No.: 10/668,515

(22) Filed: Sep. 23, 2003

(51) Int. Cl. G01N 21/64

(52) U.S. Cl. 422/82.05; 73/104; 73/865.9; 436/5; 436/172

(57) ABSTRACT

The present invention is generally directed toward a method of measuring surfactant penetration into a foam layer of a filter for an air filter assembly. The method comprises the addition of a dye to a surfactant, adding the dye laden surfactant to the foam layer, illuminating the foam layer after the dye laden surfactant has been added, observing the amount of illumination, and determining the amount of surfactant penetration by the amount of illumination of the foam layer.

### BACKGROUND

1. Technical Field

This invention generally relates to an air filter assembly and more specifically to the measuring surfactant penetration in a foam filter of the air filter assembly.

2. Known Technology

It is known to provide air induction filters for the engine of a motor vehicle so as to filter out contaminants in air entering the engine. In the past, the air induction filter was typically made of pleated paper or fibrous media housed in a plastic or metal frame mounted in the engine compartment of the motor vehicle. Once the customer or service technician evaluates the filter as dirty, this filter was discarded and replaced with a new one.

Another variety of filter is made of reticulated foam and located in a plastic housing in the engine compartment. The foam material is one or more layers thick and is attached to the housing. The sealed box in combination with sufficient foam can make this a long life filter. The filter must still be replaced after many miles, but it is greatly increased from traditional filters. However, reticulated foam has at least one drawback. For example, experiments have found that untreated foam does not absorb dust very efficiently, which decreases the cleaning efficiency of the air filter. In order to increase the efficiency of the air filter, it is known to treat the filters with a contaminant attracting substance, such as an oil or surfactant.

Experiments have also found that the efficiency of the air filter, depends directly on the amount of oil and the depth that it has penetrated the thickness of the foam filter. Unfortunately, once the oil is added to the foam filter it is not visible, and there is no known method of measuring the distribution or the depth that it has penetrated into the foam filter.

Therefore, there is a need in the industry to be able to determine oil penetration into the foam of a filter so as to enable the maximum dust absorbing capability of the air filter.

### SUMMARY

In overcoming the drawbacks and limitations of the known technology, a method is provided to reliably determine the oil penetration into a filter of an air filter assembly. By determining the depth of oil penetration into the filter media, the manufacturing process can be modified, if necessary, to ensure that full and complete penetration of the oil occurs. This further ensures that the air filter achieves its maximum contaminant trapping ability and its longest useful life.

According to the present invention, the method of measuring oil penetration into a filter of an air intake assembly comprises: providing an oil or surfactant; adding an illuminable material to the oil or surfactant; providing a filter having at least one foam layer; applying the oil or surfactant containing the illuminable material to the foam layer; illuminating the illuminable in the oil or surfactant after being applied to the foam layer; examining the foam layer while being illuminated; and determining the depth of oil penetration based on the amount of the foam layer illuminated.

In yet another aspect, the foam layer is perforated. Perforating may occur before the oil or surfactant is added to the foam layer. After the oil or surfactant is added to the foam layer, the foam layer may be torn along the perforations. In this matter, the penetration of the oil or surfactant into the foam layer is not disturbed and an accurate determination of the depth of penetration may be made.

In still another aspect, the foam layer is observed under black light to measure the depth of penetration of the oil foam layer into the surfactant.

Further features and advantages of the invention will become apparent to those skilled in the art from a review of the following discussion and claims, in conjunction with the accompanying drawings.

### BRIEF DESCRIPTION OF THE DRAWINGS

FIG. 1 is a perspective view of an air filter assembly as installed in or near the engine bay of a motor vehicle;

FIG. 2 is an exploded view of the air filter assembly seen in FIG. 1;

FIG. 3 is a sectional view of the foam layers of the filter assembly seen in FIG. 2;

FIG. 4 is flow chart of the steps of a method in accordance with the teachings of the present invention;

FIG. 5 is a perspective view of a foam layer as used in connection with the present invention; and

FIGS. 6A and 6B are sectional views of a foam layer illustrating partial surfactant penetration and full surfactant penetration, respectively.

### DETAILED DESCRIPTION

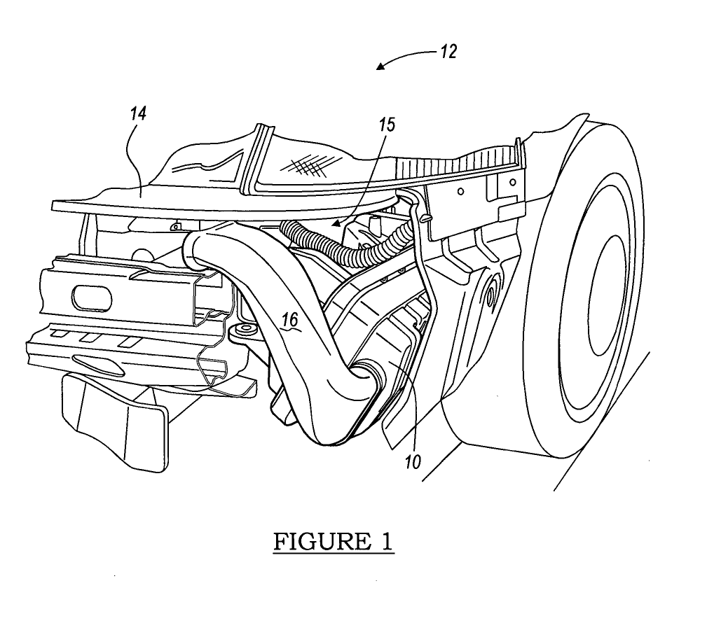

Referring now to the drawings and in particular FIG. 1, an air filter assembly 10 produced according to the principles of the present invention is illustrated as being installed in a motor vehicle 12. As shown, the motor vehicle 12 includes a vehicle body 14 defining an engine bay 15. An air inlet tube 16 is operatively connected to the air filter assembly 10 to direct air into the assembly 10. The air filter assembly 10 receives ambient air through the air inlet tube 16, filters the air and thereafter delivers the cleaned air to the engine of the motor vehicle 12. Although in this application the air filter assembly 10 is discussed as being specifically installed in the air induction system of the motor vehicle, it will be understood that the air filter assembly 10 may be used in connection with other automotive components, such as a heating/ventilation/air conditioning system (HVAC) or may be used in non-automotive application where filtered air is desired.

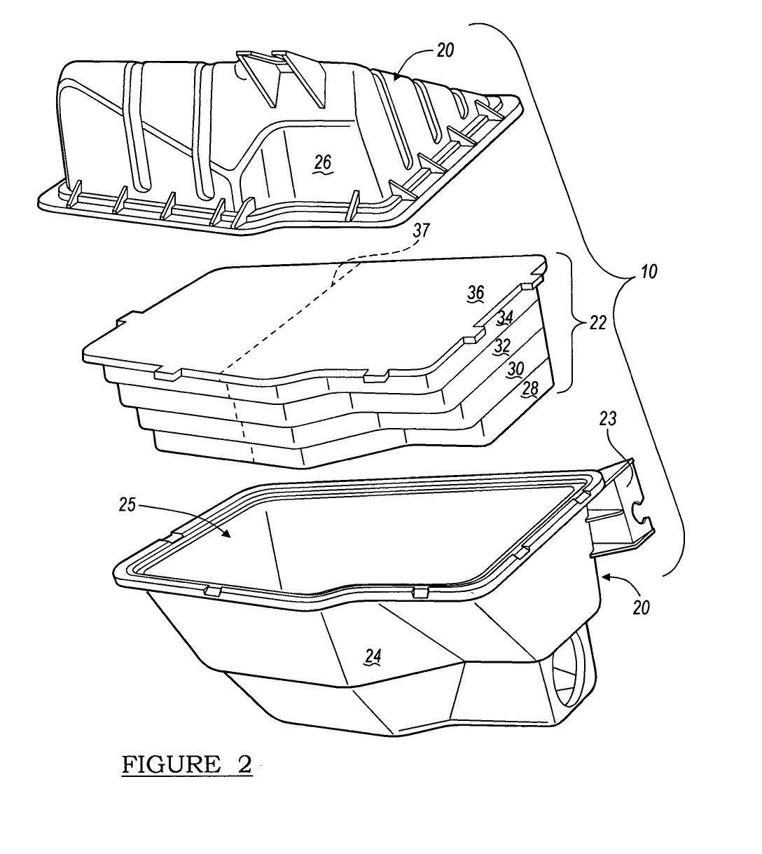

As seen in FIG. 2, the air filter assembly 10 includes a housing 20 in which a filter 22 is disposed to filter contaminants from the air supplied to the engine. The housing 20 includes a tray or body 24 on which is provided suitable means, such as a bracket 23, to mount the assembly 10 within the engine bay 15 of the motor vehicle 12. The housing 20 also includes a cover 26 that may be removeably attached to the tray 24. The tray 24 and cover 26 cooperate to define an interior cavity 25 into which the filter 22 is received. The filter 22 may have any suitable shape, but preferably is shaped complementary to the interior shape of the cavity 25. Further the filter 22 is preferably sized to substantially or fully occupy the cavity 25 of the housing, such shapes including complex geometrical shapes.

In one embodiment, the filter 22 is multi-layered having a plurality of individual layers 28, 30, 32, 34 and 36. Although in the drawings a five layer filter 22 is shown and described, it will be understood that the filter 22 can be comprised of more than or fewer than five layers. The number of layers in that the filter 22 is dictated by the particular application, manufacturing, packaging and other conditions. The thickness and the porosity of these layers 28-32 can be identical or different depending on the requirements dictated by the application in which the air filter assembly 10 is used. An example of a multi-layered air filter is described in U.S. Pat. No. 6,464,761, which is herein incorporated by reference.

The layers 28, 30, 32, 34 and 36 of the filter 22 are made of reticulated foam and are perforated along lines 37. As will be explained later, the perforations 37 are formed in the filter 22 to help expose the internal surfaces of the layers 28-32 without disturbing the oil distributions.

As mentioned above, in order to increase the contaminant absorbing capability of the filter 22, the multi-layers 28-32 of the filter 22 are treated with an oil or surfactant (hereinafter just “surfactant”). All of the layers 28-36 of the filter 22 may be treated with the surfactant or only some of the layers 28-36 may be treated as such.

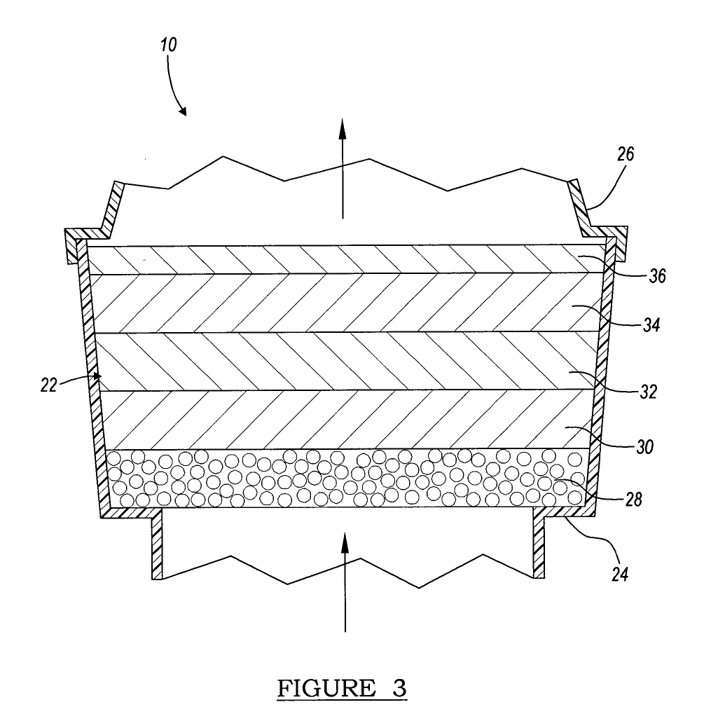

Referring to the cross-section view of the filter assembly 10 seen in FIG. 3, one layer 28 of the filter 22 is shown as having been fully treated with a surfactant. The surfactant in layer 28 is illustrated by darker lines being used to define the layer 28. It is believed that the specific surfactant is not relevant to the present invention and that any surfactant could be used. Since the efficiency of the filter 22 depends on the depth of surfactant penetration into the layer 28, it is important to measure the surfactant penetration. With the present invention this is achieved in part by pre-treating the surfactant before it is added to the layer 28.

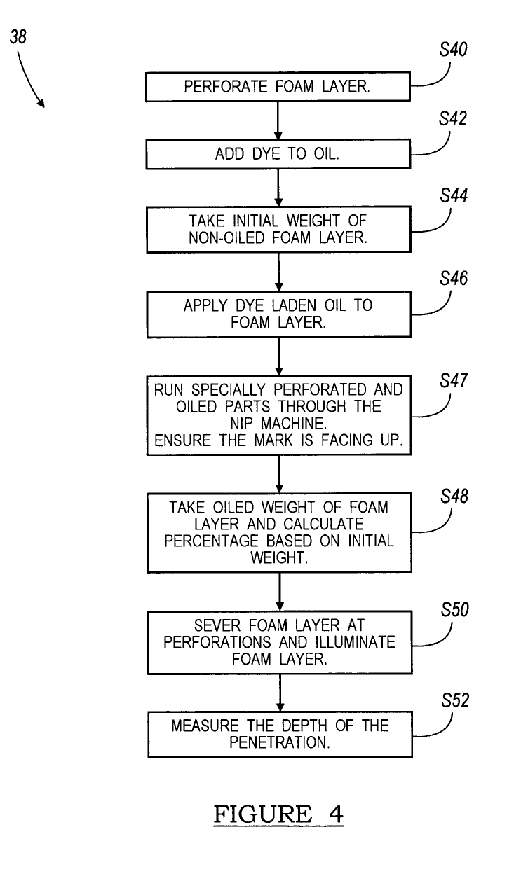

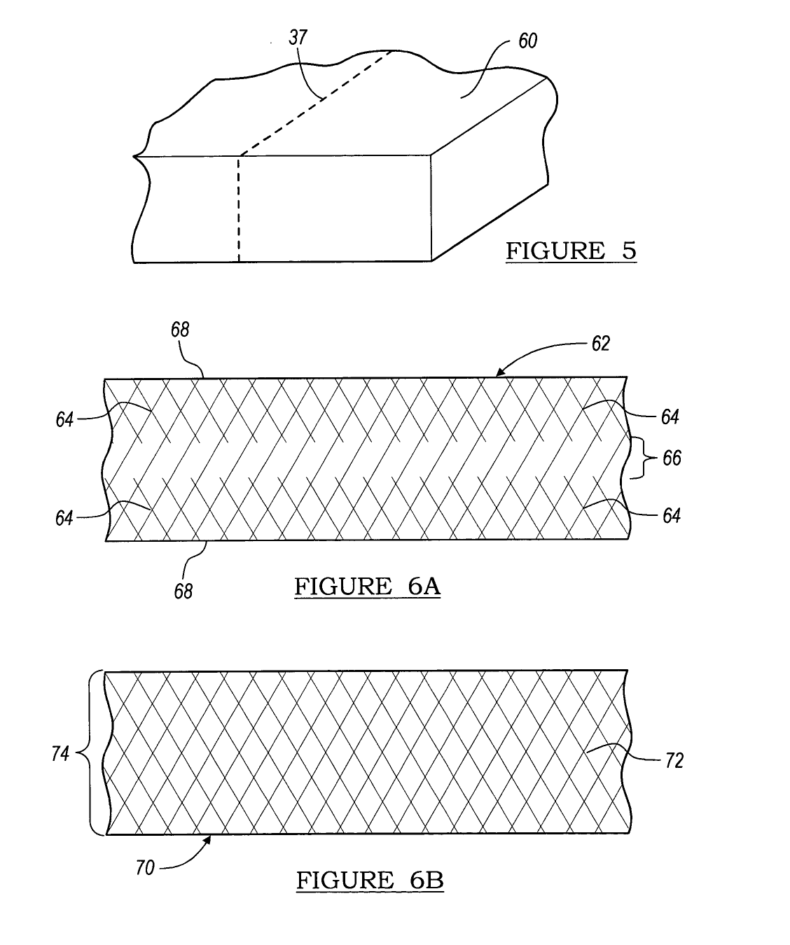

As detailed in the flowchart of FIG. 4 and seen in FIGS. 5 and 6, a method of measuring surfactant penetration into a foam layer 60 or layers of a filter is generally shown and represented by reference number 38. The method first comprises the step S40 of providing a layer of foam 60 and forming within the layer(s) perforations 37. As discussed below, the perforations 37 enable the layer(s) 60 to be severed without impacting the measurements to be taken. In step S42 a pre-determined amount of dye is added to a surfactant. Approximately, 0.1 grams of dye is used per liter of surfactant. The dye used is preferably a florescent dye capable of being illuminated under black light, however, other illumination means could be used. The florescent dye may be a dry, solvent based dye or an other suitable dye/illuminable material. The method next comprises the step S44 of initially weighing the foam layer 60 before the dye laden surfactant is added to the foam layer 60.

The dye laden surfactant is then added to the foam layer 60 in step S46. The dye laden surfactant is added to the with the help of an oiler machine and evenly distributed in the foam layer 60 with the help of a nip machine in step S47. The quantity of dye laden surfactant added to a given foam layer 60 generally depends on the thickness and porosity of the given layer 60. For example, if the porosity of the layer is 80 ppi (pores per inch) then the amount of dye laden oil added would be approximately 7.5 grams per 13 grams of foam. With a porosity of 30 ppi, then the amount of dye laden surfactant added to the layer(s) 60 is approximately 12 grams per 35 grams of foam.

In step S48, the weight of the foam layer 60 after the dye laden surfactant has been added is taken. Once the foam layer 60 has been weighed, the foam layer 60 is severed in step S50 along perforations 37 made in step S40. Perforating the foam layer 60 ensures that the surfactant distribution in the foam layer 60 is not disturbed or otherwise impacted upon severing for testing. Once the foam layer 60 has been torn along the perforations, the severed foam layer 62 is illuminated with black light or other means and is examined. Illuminated in this manner, the depth of penetration of the dye laden surfactant into the foam layer 62 is measured, visually or otherwise. Partial penetration occurs as seen in FIG. 6A, when the full depth or thickness of the severed foam layer 62 is not illuminated. As seen in this figure, the penetration of the surfactant is identified at 64 and the portion of the foam layer 62 not penetrated by the surfactant is identified at 66. Surfactant penetration depth, when less than complete, is measured as the combined depth of penetration from the two exterior sides (the top and bottom sides 68) of the foam layer 62. Full penetration occurs when the complete thickness of the foam layer 70 appears illuminated. As seen in FIG. 6B, full surfactant penetration is identified by the cross hatching at 72 and the penetration is seen as being through the full depth or thickness 74 of the foam layer 70.

As a person skilled in the art will recognize from the above description, taken in conjunction with the figures and claims, modifications, variations and changes can be made without departing from the proper scope and fair meaning of the invention, as defined in the claims that follow.

1. A method of measuring surfactant penetration into a filter of an air filter assembly for an intake system, the method comprising:
providing a surfactant;
adding illuminable material to the surfactant;
providing a filter having at least one foam layer;
applying the surfactant containing the illuminable material to the foam layer;
illuminating the illuminable material in the surfactant after being applied to the foam layer;
examining the foam layer while being illuminated; and
determining the depth of surfactant penetration based on an illuminated area of the foam layer.

2. The method of claim 1, further comprising the step of weighing the foam layer before applying the oil surfactant containing illuminable material.

3. The method of claim 1, further comprising the step of weighing the foam layer after applying the oil surfactant containing the illuminable material.

4. The method of claim 1, wherein the step of adding the illuminable material adds a florescent dye.

5. The method of claim 1, wherein the step of adding illuminable material adds dye at the rate of at least about 0.1 grams per quart of surfactant.

6. The method of claim 1, further comprising the step of severing the foam layer into a predetermined size.

7. The method of claim 1, further comprising the step of perforating the foam layer to form perforations therein.

8. The method of claim 7, further comprising the step of severing the foam layer along perforations formed in the perforating step.

9. The method of claim 8, wherein the examining step examines the foam layer at the location at which the foam layer was severed in the severing step and wherein the determining step is based on the illuminated area at a location where the foam layer was severed.

10. The method of claim 1 further comprising the step of dispersing the surfactant containing the dye in the foam layer.

11. The method of claim 1 wherein the foam layer defines a thickness thereof and the determining step is based on the illuminated area of thickness of the foam layer.
